(19) United States
(12) Patent Application Publication
(10) Pub. No.: US 2026/0172106 A1
(43) Pub. Date: Jun. 18, 2026

(54) Communications System with Post Coverage Gap Congestion Mitigation

(71) Applicant: Apple Inc., Cupertino, CA (US)

(72) Inventors: Shahram Talakoub, San Jose, CA (US); Sebastian B Seeber, San Carlos, CA (US); Sudeep Bhattarai, Fremont, CA (US)

(21) Appl. No.: 18/981,235

(22) Filed: Dec. 13, 2024

(51) Int. Cl. H04B 7/185; H04W 28/02; H04W 84/06

(52) U.S. Cl. CPC H04B 7/18519; H04W 28/0289; H04W 84/06

(57) ABSTRACT

A communications system may include user equipment (UE) devices that communicate with a core network via serving nodes. The UE devices may communicate via a first serving node during a first period and via a second serving node during a second period separated from the first coverage period by a gap. The UE devices may receive congestion levels of the first serving node during the first period and of the second serving node during the second period. To break the deterministic transmission pattern of the UE devices while recovering from the coverage gap, the UE devices may use a congestion level of the first serving node for a predetermined number of cycles after the gap until the second serving node detects congestion. This may help to prevent a thundering herd condition, reducing latency with which the UE devices are able to reconnect to the core network after the gap.

### FIELD

This relates generally to wireless communications, including wireless communications by user equipment devices.

### BACKGROUND

Communications systems are used to convey data between terminals such as user equipment (UE) devices. In performing wireless communications, a UE device wirelessly transmits data to a wireless network. The wireless network forwards the data to an intended recipient device.

In practice, some wireless networks exhibit limited speed and/or bandwidth in communicating with UE devices. If care is not taken, a UE device will need to wait an excessive amount of time to successfully transmit data over such a wireless network, which can be detrimental to user experience.

### SUMMARY

A communications system may include user equipment (UE) devices that communicate with a core network via a set of serving nodes. The set of UE devices may overlap a coverage area of a first serving node during a first coverage period. The set of UE devices may receive broadcast messages that identify congestion levels of the first serving node during system cycles of the first coverage period. The set of UE devices may enter a coverage gap after a last system cycle of the first coverage period. The set of UE devices may be unable to communicate with the core network during the coverage gap.

The set of UE devices may overlap a coverage area of a second serving node during a second coverage period that is separated from the first coverage period by the coverage gap. The set of UE devices may receive broadcast messages that identify congestion levels of the second serving node during system cycles of the second coverage period. For N system cycles after the end of the coverage gap, the UE devices in the set may perform their respective first reverse link transmissions after the coverage gap during system cycles that are probabilistically selected based on a higher of the congestion level of the first serving node during the last system cycle of the first coverage period and the most recent congestion level of the second serving node. After N cycles, the UE devices in the set may perform their respective first reverse link transmissions after the coverage gap during system cycles that are probabilistically selected based on the most recent congestion level of the second serving node. This may help to prevent a thundering herd condition, reducing latency with which the set of UE devices are able to reconnect to the core network after the coverage gap.

An aspect of the disclosure provides a method of operating a user equipment (UE) device to communicate with a core network via a constellation of satellites. The method can include receiving, from the core network via a first satellite in the constellation, a first broadcast message that identifies a first congestion level of the first satellite. The method can include receiving, from the core network via a second satellite in the constellation, a second broadcast message that identifies a second congestion level of the second satellite. The method can include transmitting, based on a higher of the first congestion level and the second congestion level, a reverse link message to the core network via the second satellite.

An aspect of the disclosure provides a method of operating an electronic device to communicate with a core network. The method can include receiving, from the core network via a first serving node, a first congestion level of the first serving node during a last system cycle of a first coverage period. The method can include receiving, from the core network via a second serving node, a second congestion level of the second serving node during an earliest system cycle of a second coverage period, wherein the second coverage period is separated from the first coverage period by a coverage gap during which the electronic device is unable to communicate with the core network. The method can include transmitting, to the core network via the second serving node, an uplink signal during a system cycle of the second coverage period that is probabilistically selected, by the electronic device, based on the first congestion level when the first congestion level is greater than the second congestion level.

An aspect of the disclosure provides a method of operating a core network to communicate with a set of user equipment (UE) devices via a constellation of satellites. The method can include transmitting, to the set of UE devices via a first satellite in the constellation during a first coverage period, a first broadcast message that identifies a first congestion level of a first signal beam of the first satellite, the first signal beam overlapping the set of UE devices. The method can include transmitting, to the set of UE devices via a second satellite in the constellation during a second coverage period, a second broadcast message that identifies a second congestion level of a second signal beam of the second satellite, the second signal beam overlapping the set of UE devices, and the second coverage period being separated from the first coverage period by a coverage gap during which the core network is unable to communicate with the set of UE devices. The method can include receiving earliest reverse link transmissions after the coverage gap by the set of UE devices, the earliest reverse link transmissions being received via the second signal beam of the second satellite during a set of system cycles that are probabilistically selected, by the set of UE devices, based on a higher of the first congestion level and the second congestion level.

### BRIEF DESCRIPTION OF THE DRAWINGS

FIG. 1 is a diagram of an illustrative communications system including user equipment devices that communicate with a core network in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a schematic diagram of an illustrative core network in accordance with some embodiments.

FIG. 5 is a diagram showing how a set of user equipment devices may communicate with a core network during coverage periods that are separated by a coverage gap in accordance with some embodiments.

FIG. 6 is a timing diagram of illustrative broadcast messages transmitted to user equipment devices by a core network in accordance with some embodiments.

FIG. 7 is a flow chart of illustrative operations that may be performed by a user equipment device to communicate with a core network while mitigating congestion associated with uplink transmission by a set of user equipment devices after a coverage gap in accordance with some embodiments.

FIG. 8 is a timing diagram showing one example of how the first uplink transmissions by a set of illustrative user equipment devices may be spread across multiple system cycles after a coverage gap in accordance with some embodiments.

FIG. 9 is a flow chart of illustrative operations that may be performed by a core network to communicate with a set of user equipment devices in accordance with some embodiments.

### DETAILED DESCRIPTION

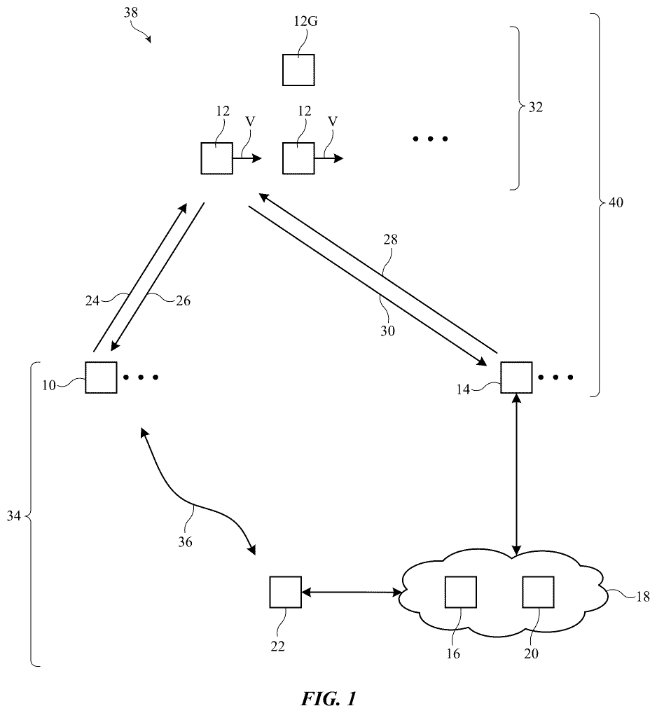

FIG. 1 is a diagram of an illustrative communications system 38. Communications system 38 (sometimes referred to herein as communications network 38, network 38, system 38, satellite communications system 38, or satellite communications network 38) may include a ground-based (terrestrial) gateway system that includes one or more gateways 14 and may include one or more user equipment (UE) devices 10. Gateways 14 and UE devices 10 may form a part of a terrestrial network 34 on Earth. Terrestrial network 34 may include terrestrial-based wireless communications equipment 22 and network portion 18. Terrestrial-based wireless communications equipment 22 may include, for example, one or more wireless base stations (e.g., for implementing a cellular telephone network), wireless access points (e.g., for implementing a wireless local area network (WLAN)), and/or other UE devices (e.g., for implementing a device-to-device (D2D) network, a wireless personal area network (WPAN), etc.).

Communications system 38 may include a constellation 32 of one or more communications satellites 12 and 12G (sometimes referred to herein simply as satellites 12 and 12G). UE devices 10, gateways 14, and constellation 32 may form a part of non-terrestrial network (NTN) 40, which conveys signals between UE devices 10 and gateways 14 via constellation 32. Constellation 32 may sometimes be referred to herein as satellite constellation 32. Communications satellites 12 and 12G are located in space (e.g., in orbit around Earth). Communications system 38 may include any desired number of gateways 14, any desired number of communications satellites, and any desired number of UE devices 10. Only a single gateway 14, three communications satellites, and a single UE device 10 are illustrated in FIG. 1 for the sake of clarity. Each gateway 14 in communications system 38 may be located at a different respective geographic location on Earth (e.g., across different regions, cities, counties, prefectures, districts, municipalities, land masses, areas, localities, states, provinces, countries, continents, etc.).

Network portion 18 may be communicatively coupled to terrestrial-based wireless communications equipment 22 and each of the gateways 14 in communications system 38. Gateway (GW) 14 may include a satellite network ground station and may therefore sometimes also be referred to as ground station (GS) 14 or satellite network ground station 14. Each gateway 14 may include one or more antennas (e.g., electronically and/or mechanically adjustable antennas), modems, transceivers, amplifiers, beam forming circuitry, control circuitry (e.g., one or more processors, storage circuitry, etc.) and other components that are used to convey communications data. The components of each gateway 14 may, for example, be disposed at a respective geographic location (e.g., within the same computer, server, data center, building, etc.). Gateways 14 may convey communications data between terrestrial network 34 and UE devices 10 via satellite constellation 32.

Network portion 18 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as UE devices 10, and/or any other desired network components. The network nodes in network portion 18 may include physical components such as electronic devices, servers, computers, user equipment, etc., and/or may include virtual components that are logically defined in software and that are distributed across (over) two or more underlying physical devices (e.g., in a cloud network configuration).

Network portion 18 may include one or more satellite network operations centers such as network operations center (NOC) 16. NOC 16 may control the operation of gateways 14 in communicating with satellite constellation 32. NOC 16 may also control the operation of the satellites in satellite constellation 32. For example, NOC 16 may convey control commands via gateways 14 that control positioning operations (e.g., orbit adjustments), sensing operations (e.g., thermal information gathered using one or more thermal sensors), and/or any other desired operations performed in space by satellites 12. NOC 16, gateways 14, and satellite constellation 32 may be operated or managed by a corresponding satellite constellation operator.

Communications system 38 may also include a satellite communications (satcom) network service provider (e.g., a satcom network carrier or operator) for controlling wireless communications between UE devices 10 and terrestrial network 34 via satellite constellation 32. The satcom network service provider may be a different entity than the satellite constellation operator that controls/operates NOC 16, gateways 14, and satellite constellation 32, or may be the same entity as the satellite constellation operator. Terrestrial-based wireless communications equipment 22 in terrestrial network 34 may be operated by one or more terrestrial network carriers or service providers. The terrestrial network carriers or service providers may be different entities than the satcom network service provider or, if desired, may be the same entity as the satcom network service provider.

One or more gateways 14 may control the operations of satellite constellation 32 over corresponding radio-frequency communications links. Satellite constellation 32 may include any desired number of satellites (e.g., two satellites, four satellites, ten satellites, dozens of satellites, hundreds of satellites, thousands of satellites, etc.), three of which are shown in FIG. 1. If desired, two or more of the satellites in satellite constellation 32 may convey radio-frequency signals between each other using satellite-to-satellite (e.g., relay) links.

Constellation 32 may include a set of non-geostationary orbit (NGSO) satellites (e.g., satellites in non-geostationary orbits) and, if desired, may include a set of geostationary orbit (GSO) satellites (e.g., satellites in geostationary/geosynchronous orbits, sometimes referred to as geosynchronous satellites or GEO satellites). The satellites 12 of constellation 32 as described herein are NGSO satellites (e.g., satellites 12 may be in NGSO orbits and may sometimes be referred to herein as NGSO satellites 12). Satellites 12 therefore move relative to the surface of Earth over time (e.g., at velocities V relative to the surface of Earth). The satellites 12G of constellation 32 are GSO satellites (e.g., satellites 12G may be in GSO orbits and may sometimes be referred to herein as GSO satellites 12G). GSO satellites 12G do not move relative to the surface of Earth (e.g., GSO satellites 12G may orbit around Earth at a velocity that matches the rotation of Earth given the altitude of the satellites).

GSO satellites 12G may orbit Earth at orbital altitudes of greater than around 30,000 km. Satellites 12 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellite in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit and/or each at a different orbital altitude. In general, constellation 32 may include satellites in any desired combination of orbits or orbit types. GSO satellites 12G may be omitted from constellation 32 if desired.

The satellites in constellation 32 may communicate with one or more UE devices 10 on Earth using one or more radio-frequency communications links (e.g., satellite-to-user equipment links). Satellites 12 and 12G may also communicate with gateways 14 on Earth using radio-frequency communications links (e.g., satellite-to-gateway links). Radio-frequency signals may be conveyed between UE devices 10 and satellites 12/12G and between satellites 12/12G and gateways 14 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications bands. If desired, different bands may be used for the satellite-to-user equipment links than for the satellite-to-gateway links.

Communications may be performed between gateways 14 and UE devices 10 in a forward (FWD) link direction and/or in a reverse (REV or RWD) link direction. In the forward link direction (sometimes referred to simply as the forward link), wireless data is conveyed from gateways 14 to UE device(s) 10 via satellite constellation 32. Wireless data conveyed over the forward link is sometimes referred to herein as forward link data. Forward link data may be organized into a set, series, or stream of forward link datagrams (e.g., having header fields that contain header information, payload fields that contain a forward link data payload, etc.). A gateway 14 may, for example, transmit forward link data to one of the satellites 12 in satellite constellation 32 (e.g., where forward link datagrams are modulated onto one or more carriers of radio-frequency signals 28). Satellite 12 may transmit (e.g., relay, in a bent-pipe configuration) the forward link data received from gateway 14 to UE device(s) 10 (e.g., using radio-frequency signals 26). Radio-frequency signals 28 are conveyed in an uplink direction from gateway 14 to satellite 12 and are therefore sometimes also referred to herein as uplink (UL) signals 28, forward link UL signals 28, or forward link signals 28. Radio-frequency signals 26 are conveyed in a downlink direction from satellite 12 to UE device(s) 10 and are therefore sometimes also referred to herein as downlink (DL) signals 26, forward link DL signals 26, or forward link signals 26.

In the reverse link direction (sometimes referred to simply as the reverse link), wireless data is conveyed from UE device(s) 10 to gateways 14 via satellite constellation 32. Wireless data conveyed over the reverse link is sometimes referred to herein as reverse link data. Reverse link data may be organized into a set, series, or stream of reverse link datagrams (e.g., having header fields that contain header information, payload fields that contain a reverse link data payload, etc.). One of UE devices 10 may, for example, transmit reverse link data to one of the satellites 12 in constellation 32 (e.g., where reverse link datagrams are modulated onto one or more carriers of radio-frequency signals 24). Satellite 12 may transmit (e.g., relay, in a bent-pipe configuration) the reverse link data received from UE device 10 to a corresponding gateway 14 using radio-frequency signals 30. Radio-frequency signals 24 are conveyed in an uplink direction from UE device 10 to satellite 12 and are therefore sometimes also referred to herein as uplink (UL) signals 24, reverse link UL signals 24, or reverse link signals 24. Radio-frequency signals 30 are conveyed in a downlink direction from satellite 12 to gateway 14 and are therefore sometimes also referred to herein as downlink (DL) signals 30, reverse link DL signals 30, or reverse link signals 30. Gateway 14 may forward wireless data between UE device(s) 10 and network portion 18. Network portion 18 may forward the wireless data to any desired network nodes or terminals of terrestrial network 34.

If desired, UE devices 10 may also convey radio-frequency signals with terrestrial-based wireless communications equipment 22 over terrestrial network wireless communication links 36 when available. UE devices 10 may sometimes be referred to herein as being “online” or “on-grid” when the UE devices are within range of terrestrial-based wireless communications equipment 22 and when terrestrial-based wireless communications equipment 22 provides access (e.g., communications resources) to network portion 18 for the UE devices. When the UE devices are online, the UE devices may communicate with other network nodes or terminals in network portion 18 via terrestrial network wireless communications links 36. Conversely, UE devices 10 may sometimes be referred to herein as being “offline” or “off-grid” when the UE devices are out of range of terrestrial-based wireless communications equipment 22 or when terrestrial-based wireless communications equipment 22 does not provide access to network portion 18 for the UE devices (e.g., when terrestrial-based wireless communications equipment 22 is disabled due to a power outage, natural disaster, traffic surge, or emergency, when terrestrial-based wireless communications equipment 22 denies access to network portion 18 for the UE devices, when terrestrial-based wireless communications equipment 22 is overloaded with traffic, etc.).

If desired, UE devices 10 may include separate antennas for handling communications over the satellite-to-user equipment link and one or more terrestrial network wireless communication links 36 or UE devices 10 may include a single antenna that handles both the satellite-to-user equipment link and the terrestrial network wireless communications links. The terrestrial network wireless communications links may be, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, etc.), wireless local area network links (e.g., Wi-Fi® links), wireless personal area network links (e.g., Bluetooth links), D2D links, etc.

The wireless data conveyed in DL signals 26 is sometimes also referred to herein as DL data, forward link DL data, or forward link data. UL signals 28 may also convey the forward link data (e.g., forward link data that is routed by satellite 12 to UE device(s) 10 in DL signals 26). The wireless data conveyed in UL signals 24 is sometimes also referred to herein as UL data, reverse link UL data, or reverse link data. The reverse link data may be generated and transmitted by UE device(s) 10. DL signals 30 may also convey the reverse link data. Forward link data may be generated by any desired network nodes or terminals of terrestrial network 34. Forward link data and the reverse link data may include text data such as email messages, text messages, web browser data, an emergency or SOS message, a location message identifying the location of UE device(s) 10, or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device(s) 10), cloud network synchronization data, data generated or used by software applications running on UE device(s) 10 (e.g., application data), data for use in a distributed processing network, and/or any other desired data. UE devices 10 may only receive forward link data, may only transmit reverse link data, or may both transmit reverse link data and receive forward link data. Each satellite 12/12G may communicate with the UE devices 10 located within its coverage area at any given time (e.g., UE devices 10 located within cells on Earth that overlap the signal beam(s) producible by the satellite).

The satcom network service provider for communications system 38 may operate, control, and/or manage a satcom control network such as core network (CN) 20 in network portion 18. CN 20 may sometimes also be referred to herein as satcom network region 20, CN region 20, satcom controller 20, satcom network 20, or satcom service provider equipment 20. CN 20 may be implemented on one or more network nodes and/or terminals of network portion 18 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to herein as a CN cloud region or satcom network cloud region.

CN 20 may control and coordinate wireless communications between terminals (e.g., end hosts) of terrestrial network 34 and UE devices 10 via satellite constellation 32. For example, gateways 14 may receive reverse link data from UE devices 10 via satellite constellation 32 and may route the reverse link data to CN 20. CN 20 may perform any desired processing operations on the reverse link data. For example, CN 20 may identify destinations for the reverse link data and may forward the reverse link data to the identified destinations. CN 20 may also receive forward link data for transmission to UE devices 10 from one or more terminals or end hosts of terrestrial network 34 (e.g., network portion 18). CN 20 may process the forward link data to schedule the forward link data for transmission to UE devices 10 via satellite constellation 32. CN 20 may schedule the forward link data for transmission to UE devices 10 by generating forward link traffic grants for each of the UE devices that are to receive forward link data. CN 20 may provide the forward link data and the forward link traffic grants to gateways 14. Gateways 14 may transmit the forward link data to UE devices 10 via satellite constellation 32 according to the forward link traffic grants (e.g., according to a forward link communications schedule that implements the forward link traffic grants). CN 20 may include, be coupled to, and/or be associated with one or more content delivery networks (CDNs) that provide content for delivery to UE devices 10.

The time resources used for communications between CN 20 and a UE device 10 may be divided into a series of repeating system cycles over time (sometimes also referred to as system frames). Each system cycle may include a respective downlink (forward link) cycle and/or a respective uplink (reverse link) cycle. During each forward link cycle, CN 20 transmits a broadcast message to each of the UE devices 10 served by a given satellite 12 via that satellite 12. CN 20 may also transmit one or more unicast messages (e.g., containing forward link data) to one or more of the UE devices 10 during the forward link cycle (e.g., during a portion of the forward link cycle not occupied by the broadcast message). During a reverse link cycle, a UE device 10 may transmit a reverse link message (e.g., containing reverse link data) to CN 20 via its serving satellite 12. The reverse link message may include, for example, one or two reverse link datagrams. The reverse link cycle may have the same duration as the forward link cycle or may have a different duration. Each system cycle may have a duration (period) of between 2 seconds and 3 seconds (e.g., 2.56 seconds), between 1 second and 10 seconds, between 1 second and 5 seconds, greater than 1 second, greater than 2 seconds, less than 5 seconds, less than 10 seconds, or other durations.

UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

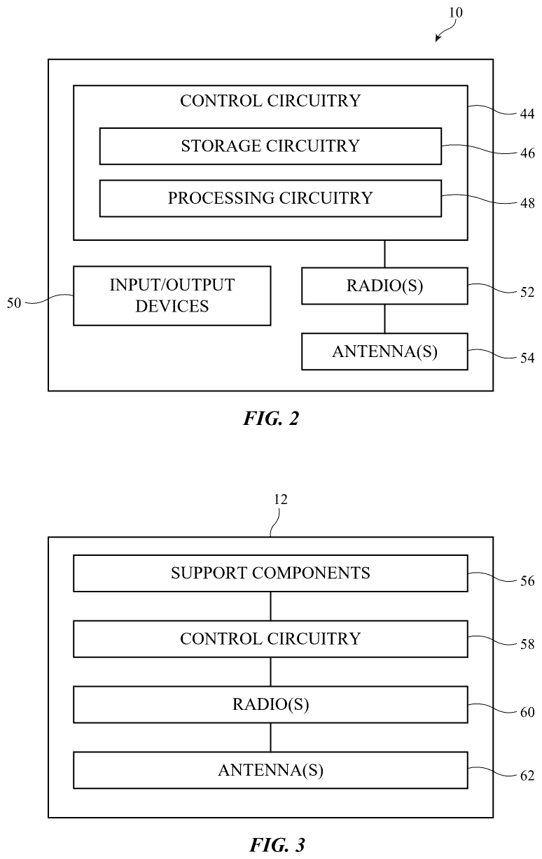

As shown in FIG. 2, UE device 10 may include components located on or within an electronic device housing such as housing 42. Housing 42, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors (e.g., microprocessors, microcontrollers, digital signal processors, host processors, baseband processor integrated circuits, application specific integrated circuits, central processing units (CPUs), graphics processing units (GPUs), etc.). Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code may sometimes be referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

UE device 10 may store satellite information associated with one or more of the satellites 12 in satellite constellation 32 on storage circuitry 46. The satellite information, sometimes referred to herein as ephemeris data, ephemeris information, or simply as satellite ephemeris, may include a satellite almanac or another data structure identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include one or more two-line elements (TLEs), for example. A TLE may identify or include information about the orbital motion of one or more of the satellites 12 in satellite constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris to calculate, predict, or identify the location of satellites 12 at a given point in time.

UE device 10 may also include wireless circuitry to support wireless communications. The wireless circuitry may include one or more antennas 54 and one or more radios 52. Each radio 52 may include circuitry that operates on signals at baseband frequencies (e.g., baseband processing circuitry, one or more baseband processors, etc.), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1(FR1 ) bands below 10 GHz, 5G New Radio Frequency Range 2(FR2 ) bands between 20 and 60 GHz, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Although control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, orientation sensors, inertial measurement units, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link). UE device 10 may be owned and/or operated by an end user.

A gateway 14 (FIG. 1) may include one or more radios that include one or more components similar to radio(s) 52, one or more antennas, one or more input/output devices, and control circuitry that includes one or more components similar to control circuitry 44. Unlike UE devices 10, gateway 14 is stationary and remains at a fixed location on Earth. Gateways 14 are not owned or operated by end users of UE devices 10. Gateway 14 may include one or more electronic devices. The electronic device(s) of a gateway 14 may be enclosed within a housing, enclosure, building, etc.

FIG. 3 is a diagram of an illustrative satellite 12 in communications system 38. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In some implementations, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam (e.g., a spot beam) in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams if desired. If desired, satellite 12 may offload some or all of its beam forming operations to gateway 14. The signal beams may sometimes be referred to herein simply as beams.

If desired, radios 60 and antennas 62 may support communications using multiple polarizations. For example, radios 60 and antennas 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). Antennas 62 may be able to produce a set of different signal beams at different beam pointing angles (e.g., where each beam overlaps a respective cell on Earth). If desired, the set of signal beams may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is illustrative and, in general, satellite 12 may produce any desired number of signal beams having any desired polarizations. A satellite 12 may, for example, transmit (forward) one or more broadcast messages and/or one or more forward link datagrams and/or may receive one or more reverse link datagrams using some or all of its signal beams during each system cycle of communications between UE devices 10 and CN 20. Different signal beams may, for example, be active during different respective subsets of each system cycle. In other implementations, multiple signal beams may be active during the same portion(s) of each system cycle.

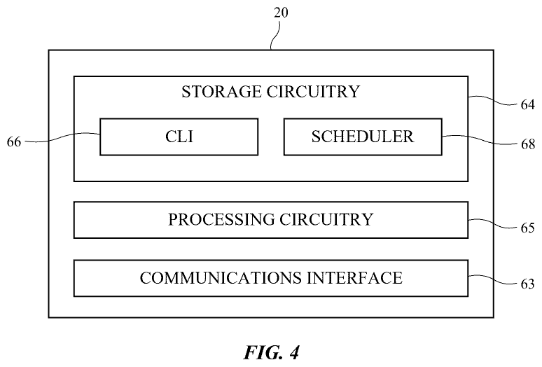

FIG. 4 is a schematic diagram of CN 20. The components of CN 20 may be implemented on one or more underlying physical devices in network portion 18 (FIG. 1). As shown in FIG. 4, CN 20 may include storage circuitry 64 (e.g., similar to storage circuitry 46 of FIG. 2) and processing circuitry 65 (e.g., similar to processing circuitry 48 of FIG. 2). CN 20 may also include one or more communications interfaces such as communications interface 63.

Storage circuitry 64 may store a communications scheduler such as scheduler 68 (e.g., a software-based scheduler that is executed using processing circuitry 65). Scheduler 68 may store communications schedules (e.g., forward link communications schedules) for each of the UE devices 10 that communicate with CN 20 (e.g., that communicate with CN 20 via constellation 32 of FIG. 1 while the UE devices are off grid and/or via terrestrial-based communications equipment 22 while the UE devices are on grid). Scheduler 68 may, for example, generate forward link traffic grants for the UE devices based on and/or implementing the stored communications schedules. Communications interface 63 may transmit forward link data (e.g., as received from another UE device, a CDN, or another data source, terminal, or end host in communications system 38) to UE devices 10 via constellation 32 and gateway(s) 14 (FIG. 1). Communications interface 63 may also receive reverse link data from UE devices 10 via constellation 32. Communications interface 63 may forward the reverse link data to a corresponding destination (e.g., another UE device, data destination, terminal, or end host in communications system 38). Communications interface 63 may include a wired communications interface (e.g., a cabled interface, an optical interface, etc.) and/or a wireless communications interface (e.g., wireless communications circuitry having one or more antennas).

Storage circuitry 64 may also store congestion level information (CLI) 66. Congestion level information 66 may identify a current congestion level for each satellite 12 in constellation 32. The congestion level of a given satellite 12 is a quantity that characterizes the amount of data traffic currently being handled by that satellite and/or the amount of data traffic congestion currently being experienced by that satellite (e.g., given that satellite's bandwidth, power, beamforming capabilities, and/or other available communications resources). Congestion level may be characterized and stored on a per-satellite basis (e.g., where CLI 66 includes a current congestion level for each satellite 12) and/or may be characterized and stored on a per-beam basis (e.g., where CLI 66 includes a current congestion level for each signal beam of each satellite 12).

A satellite 12 (or a signal beam of the satellite) that is currently serving a relatively high number of UE devices generally exhibits a relatively high congestion level. On the other hand, a satellite 12 (or a signal beam of the satellite) that is currently serving no UE devices or a relatively low number of UE devices generally exhibits a relatively low congestion level. The magnitude of the congestion level may be identified, defined, or characterized by a corresponding congestion level indicator. The congestion level indicator may be, for example, a numeric value represented by a series of one or more bits. CN 20 may generate, refresh, and/or update CLI 66 during each system cycle of each satellite 12 (e.g., based on the amount of reverse link data and/or forward link data and/or the number of UE devices served by each beam of the satellite during each system cycle). CN 20 may store a most recent congestion level for each satellite 12 (or for each beam of each satellite 12) in CLI 66 and may, if desired, store or retain earlier congestion levels for each satellite 12 (or for each beam of each satellite 12). If desired, scheduler 68 may schedule communications with UE devices 10 via satellites 12 based on the congestion levels identified by CLI 66 (e.g., using a load balancing scheme that helps to reduce the congestion level for satellites beams that exhibit a relatively high congestion level and/or that increases the congestion level for satellite beams that exhibit a relatively low congestion level in a manner that reduces latency for each of the served UE devices).

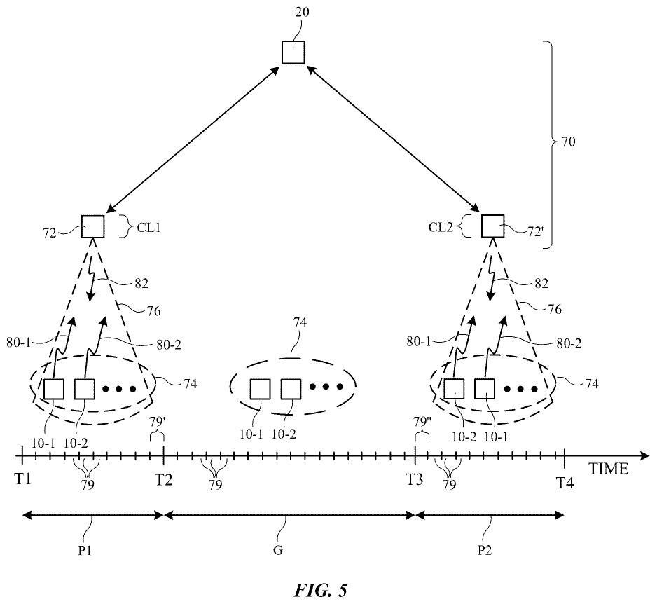

In practice, a set of UE devices 10 that is served by a signal beam of a satellite can experience one or more coverage gaps during which the set of UE devices is unable to convey wireless data with CN 20. FIG. 5 is a diagram illustrating one example in which a set of UE devices 10 experiences a coverage gap between first and second coverage periods.

As shown in FIG. 5, a set of UE devices 10 (e.g., a first UE device 10-1, a second UE device 10-2, etc.) may be located in region 74 (e.g., a geographic region or location on Earth). Communications system 38 (FIG. 1) may include a serving node 72 that wirelessly communicates with UE devices that are located within a corresponding coverage area 76 of the serving node. Coverage area 76 may overlap region 74 and thus the set of UE devices 10 within region 74. Serving node 72 may convey wireless data between UE devices within its coverage area 76 (e.g., the set of UE devices 10 in region 74) and CN 20. This is sometimes also referred to herein as serving the set of UE devices 10 in region 74 (e.g., the set of UE devices 10 in region 74 are served by serving node 72). CN 20 and serving node(s) 72 are sometimes referred to collectively herein as network 70.

A serving node 72 (sometimes also referred to as eNodeB (eNB) 72 or serving device 72) may include terrestrial-based wireless communications equipment 22 of FIG. 1 (e.g., a wireless access point, base station, etc.), may include a satellite 12 of FIG. 1, or may include aircraft flying in the atmosphere between ground level and space (e.g., unmanned aerial vehicles, commercial aircraft, private aircraft, communications balloons or airships, etc.). In implementations where serving node 72 includes terrestrial-based wireless communications equipment 22, coverage area 76 may represent a wireless coverage area (e.g., an area within which signals transmitted by the equipment at a maximum transmit power level exhibits greater than a threshold received power level), a cell, or a signal beam of the terrestrial-based wireless communications equipment. In implementations where serving node 72 includes a satellite 12, coverage area 76 may represent a signal beam of the satellite (e.g., a spot beam that illuminates region 74 from space). Implementations in which serving node 72 is a satellite 12 are sometimes described herein as an example. This is illustrative and non-limiting and, in general, serving node 72 may be any desired network node that wirelessly communicates with the set of UE devices 10 in region 74 and that conveys, routes, and/or forwards wireless data between CN 20 and the set of UE devices 10 in region 74.

The set of UE devices 10 in region 74 may wirelessly communicate with CN 20 via serving node 72 during a first coverage period P1. Coverage period P1 lasts from a first T1 until a second time T2. As shown by the horizontal time axis of FIG. 5, first coverage period P1 may be divided, in time, into a series of consecutive system cycles 79 (sometimes also referred to herein as system frames 79). Each system cycle 79 may include a respective downlink cycle (e.g., a forward link cycle) and/or a respective uplink cycle (e.g., a reverse link cycle).

During an uplink cycle, one or more UE devices 10 served by serving node 72 may transmit uplink (e.g., reverse link) data 80 to serving node 72 (e.g., UE device 10-1 may transmit uplink data 80-1, UE device 10-2 may transmit uplink data 80-2, etc.). Serving node 72 may forward the uplink data to CN 20. CN 20 may forward the uplink data to corresponding destinations in communications system 38. During each downlink cycle, CN 20 may transmit a respective broadcast message to each of the UE devices 10 in the set of UE devices served by serving node 72 via serving node 72. If desired, during each downlink cycle, CN 20 may also transmit unicast downlink data to one or more of the UE devices 10 in the set of UE devices served by serving node 72. Serving node 72 transmits downlink data (e.g., broadcast messages and unicast messages) from CN 20 to the set of UE devices 10 using downlink signals 82 (e.g., DL signals 26 of FIG. 1).

During coverage period P1, CN 20 may generate congestion level information (e.g., CLI 66 of FIG. 4) for the coverage area 76 of serving node 72 based on the amount of uplink (reverse link) and/or downlink (forward link) traffic handled by serving node 72 within coverage area 76. The congestion level information may include, for example, a respective congestion level CL1 associated with the amount of data traffic and/or traffic congestion experienced by coverage area 76 of serving node 72 (e.g., the amount of data in downlink signals 82 and/or uplink data 80) for or during each system cycle 79 of coverage period P1. CN 20 may, for example, generate a first congestion level CL1 for coverage area 76 during the first system cycle 79 of coverage period P1, may generate a second congestion level CL1 for coverage area 76 during the second system cycle 79 of coverage period P1, may generate a third congestion level CL1 for coverage area 76 during the third system cycle 79 of coverage period P1, etc.

Beginning at time T2, the set of UE devices 10 may experience a temporal gap in wireless coverage from the serving nodes of network 70. This temporal gap may last from time T2 until time T3, and is also referred to herein as coverage gap G. During coverage gap G, the set of UE devices 10 is unable to successfully transmit uplink data to CN 20 via the serving nodes 72 of network 70 and is unable to successfully receive downlink data from CN 20 via the serving nodes 72 of network 70. The last system cycle 79 of coverage period P1 prior to coverage gap G is sometimes also referred to herein as the system cycle 79′ (e.g., the most recent or latest system cycle 79 within coverage period P1 and prior to coverage gap G). The duration of coverage gap G may also be divided into a series of system cycles 79 from time T2 until time T3.

As one example, coverage gap G may occur when motion of serving node 72 relative to region 74 causes coverage area 76 to no longer overlap region 74 before the coverage area of another serving node has the chance to overlap region 74. This may occur, for example, when serving node 72 is a satellite that sets below the horizon of region 74 prior to another satellite rising above the horizon of region 74, or when serving node 72 is a satellite that no longer has a signal beam capable of overlapping region 74 prior to another satellite having a signal beam capable of overlapping region 74. As other examples, coverage gap G may occur due to bandwidth or coverage limitations of the serving nodes 72 in network 70, due to a failure, outage, emergency, or other unavailability of serving node 72, CN 20, and/or the gateway(s) 14 routing data between serving node 72 and CN 20, due to a temporary service disruption at CN 20 or serving node 72, due to a system reconfiguration pushed to the set of UE devices and/or serving node 72 (e.g., by CN 20) that causes some or all of the UE devices in the set to concurrently lose connection to serving node 72 (e.g., during update and rebooting of the UE devices to implement the system reconfiguration, when the system reconfiguration requires each of the UE devices to transmit a control message to the CN after the system reconfiguration is completed, etc.), and/or due to any other trigger event or condition that causes all or a relatively high number of the UE devices in the set to lose connection to network 70 and/or that causes all or a relatively high number of the UE devices in the set to attempt to reconnect to network 70 at the same time.

Coverage gap G ends at time T3. Beginning at time T3, a serving node 72′ of network 70 has a coverage area 76 that overlaps region 74. Serving node 72′ may begin to convey communications between the set of UE devices in region 74 and CN 20 during a second coverage period P2 lasting from time T3 until time T4. Serving node 72′ may be the same serving node 72 that serviced the set of UE devices 10 during coverage period P1 or may be a different serving node. As one example, serving node 72 may be a first satellite 12 in constellation 32 (FIG. 1) that routes communications between CN 20 and the set of UE devices 10 during coverage period P1 and serving node 72′ may be a second satellite 12 in constellation 32 that routes communications between CN 20 and the set of UE devices 10 during coverage period P2 (e.g., once the second satellite becomes visible to the set of UE devices after coverage gap G, a time period during which no satellites in the constellation are otherwise visible to the set of UE devices in region 74).

Coverage period P2 is also divided into a series of consecutive system cycles 79. Each of the system cycles 79 used for communications between the set of UE devices 10 and CN 20 via serving node(s) 72 between time T1 and time T4 may have the same duration (e.g., 2.56 seconds). The first system cycle 79 after the end of coverage gap G is sometimes also referred to herein as the first (earliest) system cycle 79″ of coverage period P2 or the first (earliest) system cycle 79″ after coverage gap G. During reverse link cycles of the system cycles 79 within coverage period P2, the set of UE devices 10 may transmit uplink (reverse link) data 80 to serving node 72′ (e.g., UE device 10-1 may transmit uplink data 80-1, UE device 10-2 may transmit uplink data 80-2, etc.). Serving node 72′ may forward uplink data 80 to CN 20. CN 20 may forward the uplink data to corresponding destinations in communications system 38. During forward link cycles of the system cycles 79 within coverage period P2, CN 20 may transmit broadcast messages and optionally unicast messages to serving node 72′. Serving node 72′ may transmit these messages to the set of UE devices 10 within its coverage area 76 using downlink signals 82.

During coverage period P2, CN 20 may generate congestion level information (e.g., CLI 66 of FIG. 4) for the coverage area 76 of serving node 72′ based on the amount of uplink (reverse link) and/or downlink (forward link) traffic handled by serving node 72′ within coverage area 76. The congestion level information may include, for example, a respective congestion level CL2 associated with the amount of data traffic and/or traffic congestion experienced by serving node 72′ within coverage area 76 (e.g., the amount of data in downlink signals 82 and/or uplink data 80) during each system cycle 79 of coverage period P2. CN 20 may, for example, generate a first congestion level CL2 for system cycle 79″, a second congestion level CL2 for the second system cycle 79 of coverage period P2, a third congestion level CL2 for the third system cycle 79 of coverage period P2, etc.

Once coverage gap G has ended, each of the UE devices 10 that experienced the coverage gap may attempt to reconnect to network 70 via serving node 72′. In some situations, in an attempt to recover communications service after coverage gap G as soon as possible (e.g., to minimize the effect of coverage gap G on user experience in communicating using the UE devices), a large number (e.g., all) of the UE devices in the set will immediately and concurrently transmit uplink signals to serving node 72′ after coverage gap G (e.g., during the first system cycle 79″ of coverage period P2). This sudden burst of uplink (e.g., reverse link) transmissions by many UE devices may produce a so-called thundering herd condition associated with the abrupt build-up of traffic congestion at serving node 72′ following the coverage gap. This can compromise link capacity (e.g., due to many UE devices attempting to use the limited wireless link resources of serving node 72′ at the same time), can deteriorate link performance for one or more of the UE devices, can cause undesirable interference or collisions between uplink transmissions by different UE devices, and/or can increase the amount of delay or latency before each of the UE devices in the set are able to reconnect to CN 20 via serving node 72′, producing a noticeable impact to user experience in performing wireless communications using UE devices 10. This type of wireless performance deterioration and delay caused by the thundering herd condition can even be dangerous to users of the UE devices when the UE devices are attempting to communicate with CN 20 in an emergency situation (e.g., for requesting assistance or emergency services while off-grid).

To help prevent a thundering herd condition after coverage gap G has ended, each UE device 10 in the set may introduce an amount of randomness to the time at which the UE device performs its first uplink transmission after time T3 in attempting to reconnect to the network. This element of randomness may help to break the deterministic transmission pattern across the set of UE devices when recovering from coverage gap G in a manner that prevents a sudden burst of excessive uplink traffic at serving node 72′. As each UE device 10 is generally unaware of the other UE devices 10 that will attempt to reconnect to the network after coverage gap G has ended, each UE device may non-deterministically transmit its first uplink transmission after coverage gap G during a system cycle 79 that is probabilistically selected by that UE device based on the congestion level CL1 of serving node 72 during the most recent system cycle 79′ of the coverage period P1 immediately preceding coverage gap G and based on the congestion level CL2 of serving node 72′ during the first system cycle 79″ of the coverage period P2 immediately after coverage gap G.

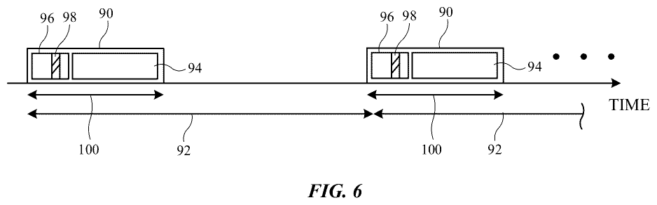

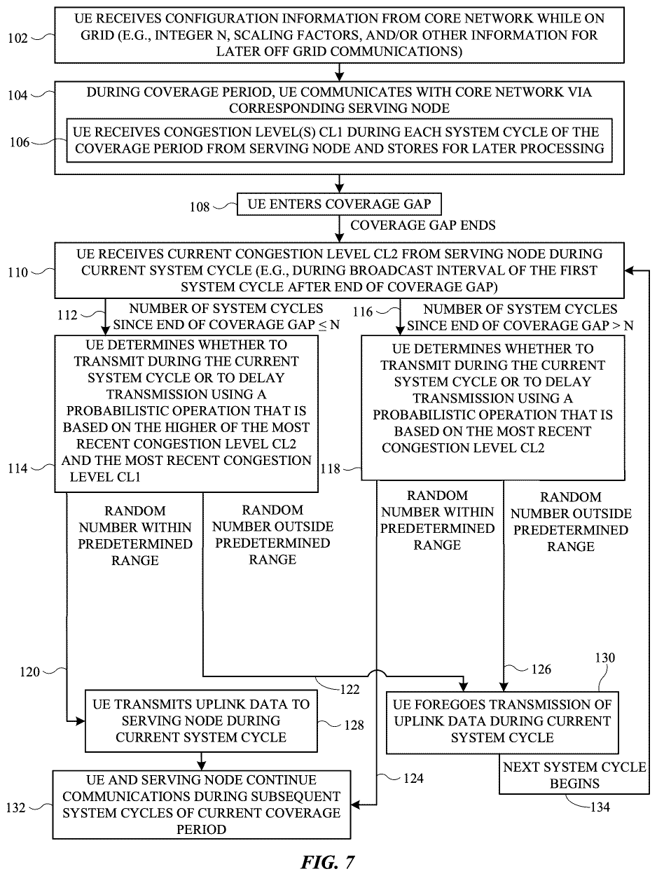

Each UE device 10 in the set may have knowledge of the respective congestion level CL1 of serving node 72 during each system cycle 79 of coverage period P1 and may have knowledge of the respective congestion level CL2 of serving node 72′ during each system cycle 79 of coverage period P2 from the broadcast messages transmitted by the serving nodes in downlink signals 82. FIG. 6 is a timing diagram showing illustrative broadcast intervals for a coverage area 76 of serving node 72 or serving node 72′ (e.g., for a given signal beam of a satellite 12).

As shown in FIG. 6, a serving node of network 70 (e.g., serving node 72 or 72′ of FIG. 5) may broadcast a respective broadcast message 90 to the UE devices 10 in its coverage area 76 during each system cycle 79. Each system cycle 79 (FIG. 5) includes a corresponding downlink (forward link) transmission cycle 92. Uplink (reverse link) transmission cycles of system cycles 79 are not shown in FIG. 6 for the sake of clarity but may, if desired, be time-interleaved with downlink transmission cycles 92 or may be at least partially concurrent with downlink transmission cycles 92. The serving node may periodically transmit a respective broadcast message 90 at the beginning of each downlink transmission cycle 92 or at another time within each downlink transmission cycle 92. Each broadcast message 90 may have a duration 100. If desired, the serving node may transmit one or more additional downlink messages (e.g., unicast messages addressed to particular UE devices) during the remaining duration of each downlink transmission cycle 92 after transmission of the corresponding broadcast message 90. Broadcast messages 90 are sometimes also referred to herein as broadcast frames 90, broadcast packets 90, or broadcast intervals 90.

CN 20 may generate broadcast messages 90 and may transmit the broadcast messages during each system cycle via the serving node. Each broadcast message 90 may include a corresponding header 96 and a corresponding payload 94. Header 96 may include a destination address field (e.g., set to a broadcast address) and/or any other desired header fields. Payload 94 may include any desired data and/or control information that is transmitted to all of the UE devices in the coverage area 76 of the serving node.

Header 96 may include a congestion level indicator 98 (e.g., within a media access control (MAC) header congestion level field of header 96). Congestion level indicator 98 may identify the current congestion level of the serving node (e.g., as calculated by CN 20 based on the uplink and/or downlink traffic of the serving node during the current and/or previous system cycle 79). Congestion level indicator 98 may, for example, include or identify the most recent congestion level CL1 when the serving node is serving node 72 (FIG. 5) and may include or identify the most recent congestion level CL2 when the serving node is serving node 72′ (FIG. 5).

Congestion level indicator 98 may, for example, include a series of one or more consecutive bits representing a congestion level as a numeric value from a lowest possible congestion level to a highest possible congestion level of the serving node. In one example, congestion level indicator 98 may be a four-bit indicator (e.g., having sixteen possible values from “0000” to “1111”). In this example, congestion level indicator 98 may represent sixteen different possible congestion levels of the serving node (e.g., from a lowest congestion level represented by the four-bit value “0000” to a highest congestion level represented by the four-bit value “1111”). This is illustrative and non-limiting and, in general, congestion level indicator 98 may include any desired number of bits and may represent different congestion levels using any desired encoding scheme.

Upon receiving each broadcast message 90, the set of UE devices in region 74 (FIG. 5) may have knowledge of the congestion level of the serving node for the corresponding system cycle 79. The UE devices may store congestion level(s) identified by received broadcast messages 90 for later use in mitigating a thundering herd condition after the end of a coverage gap G. The UE devices may store all of the received congestion levels or may store a set of one or more of the most recently received congestion levels for later processing.

FIG. 7 is a flow chart of illustrative operations that may be performed by a given UE device 10 in a manner that mitigates and/or prevents a thundering herd condition after the end of a coverage gap G. At operation 102, UE device 10 may receive configuration information from CN 20 (e.g., prior to communicating with CN 20 via serving node 72 of FIG. 5). UE device 10 may, for example, receive the configuration information from CN 20 via terrestrial-based wireless communications equipment 22 (FIG. 1) while the UE device is on-grid (e.g., prior to becoming off-grid). UE device 10 may use the configuration information to connect to and/or communicate with CN 20 via serving nodes 72 (FIG. 5) (e.g., after the UE device has moved off-grid).

The configuration information may, for example, include cryptographic keys and/or other information used to transmit and/or receive secure messages with another UE device via CN 20 and serving node(s) 72. Receiving the configuration information while UE device 10 is on-grid may help to conserve resources in bandwidth-limited situations such as when UE device 10 is off-grid and needs to communicate with CN 20 via constellation 32. The configuration information may also identify or include an integer N, one or more scaling factors, and/or other information that is used by UE device 10 to mitigate a thundering herd condition after a coverage gap G has occurred.

At operation 104, UE device 10 may be within the coverage area 76 of a corresponding serving node 72 during a first coverage such as coverage period P1 of FIG. 5. UE device 10 may be one of the set of UE devices 10 within the region 74 overlapping coverage area 76 during coverage period P1. In some implementations, UE device 10 may be off-grid during this period and/or during the remaining operations of FIG. 7. UE device 10 may communicate with CN 20 via serving node 72 during coverage period P1.

If desired, UE device 10 may transmit one or more uplink messages to CN 20 via serving node 72 during the uplink transmission cycle of one or more system cycles 79 within the first coverage period (e.g., UE device 10 may transmit one or two reverse link datagrams during each reverse link transmission cycle of one or more system cycles 79 in coverage period P1). CN 20 may forward the uplink messages to a corresponding destination. Additionally, or alternatively, CN 20 may transmit one or more downlink messages to UE device 10 via serving node 72 during the downlink transmission cycle 92 (FIG. 6) of one or more system cycles 79 within coverage period P1.

CN 20 may generate a respective congestion level CL1 associated with the coverage area 76 of serving node 72 for each system cycle 79 during coverage period P1. CN 20 may generate congestion levels CL1 based on the amount of uplink and downlink traffic during each system cycle 79 (e.g., the amount and size of the uplink messages received from the set of UE devices and the amount and size of the downlink messages transmitted to the set of UE devices during each system cycle 79). CN 20 may generate broadcast messages 90 (FIG. 6) having congestion level indicators 98 that identify the generated congestion levels CL1 (e.g., where the congestion level indicator 98 of a given broadcast message 90 identifies the congestion level CL1 of serving node 72 during the previous system cycle 79). CN 20 may transmit a respective broadcast message 90 during each system cycle 79 (e.g., during the downlink transmission cycle 100 of each system cycle 79).

UE device 10 may receive broadcast messages 90 during the downlink transmission cycle 100 of each system cycle 79 (at operation 106). UE device 10 may identify the congestion level CL1 of serving node 72 during each system cycle 79 based on the congestion level indicator 98 in the received broadcast messages 90. UE device 10 may store the identified congestion levels CL1 for later processing. UE device 10 may store and retain each identified congestion level CL1 or may store and retain only a set of one or more of the most recent congestion levels CL1 of serving node 72 (e.g., at least the congestion level CL1 of serving node 72 received during system cycle 79′ of FIG. 5).

At operation 108, UE device 10 enters coverage gap G (e.g., beginning at time T2 of FIG. 5). UE device 10 is unable to successfully transmit uplink messages to CN 20 during coverage gap G. UE device 10 is also unable to receive broadcast messages or downlink messages from CN 20 during coverage gap G. Processing proceeds to operation 110 when the coverage gap ends (e.g., at time T3 of FIG. 5).

At operation 110, UE device 10 successfully receives a broadcast message 90 from CN 20 via serving node 72′ of FIG. 5 during the downlink transmission cycle 92 (FIG. 6) of the first system cycle 79″ (FIG. 5) after coverage gap G, which also forms the first system cycle of a second coverage period P2. Receipt of the broadcast message effectively ends coverage gap G and begins the second coverage period P2. At this time, UE device 10 and the other UE devices from the set of UE devices in region 74 overlap the coverage area 76 of serving node 72′ (FIG. 5). The broadcast message 90 received during system cycle 79″ may identify, using congestion level indicator 98 (FIG. 6), the current or most recent congestion level CL2 of serving node 72 (e.g., as calculated by CN 20 at or prior to time T3). UE device 10 may store this congestion level CL2 for subsequent processing.

After UE device 10 has knowledge of the congestion level CL2 of serving node 72′, UE device 10 may perform its first uplink transmission to CN 20 after the end of coverage gap G during a system cycle that is probabilistically (non-deterministically) selected by UE device 10 based on the most recent congestion level CL2 of the coverage area 76 of serving node 72′, the most recent congestion level CL1 during the last (most recent) system cycle 79′ of coverage period P1 (prior to coverage gap G), and optionally based on the integer N and/or the scaling factor(s) included in the configuration information received while processing operation 102. The UE device may, for example, incorporate the congestion level from the previous serving node prior to coverage gap G (e.g., serving node 72) for N system cycles 79 after the end of coverage gap G. The UE device may use the highest (maximum) of the congestion level from the last serving node (e.g., the most recent congestion level CL1 received from serving node 72 prior to coverage gap G) and the currently serving node (e.g., the most recent congestion level CL2 received from serving node 72′ after coverage gap G) to perform its first uplink transmission after coverage gap G. Put differently, within N cycles, UE device 10 may use the congestion level from the last serving node until the currently serving node detects excessive congestion. UE device 10 performs an uplink transmission based on a congestion level by, for example, determining whether to (a) perform the uplink transmission during the current system cycle 79 or (b) delay the uplink transmission to a later system cycle 79 based on the congestion level (e.g., where higher congestion levels increase the probability that the UE device will delay the uplink transmission until a later system cycle 79). One example of how UE device 10 may perform its first transmission after coverage gap G is shown by operations 114-130 of FIG. 7.

If/when the number of system cycles 79 since the end of coverage gap G is less than or equal to integer N, processing may proceed from operation 110 to operation 114 via path 112. Integer N may be set by CN 20 and UE device 10 may identify integer N from the configuration data received while processing operation 102. Integer N may be equal to two, three, four, five, six, seven, eight, nine, ten, between one and ten, or higher than ten, as examples. On the other hand, if/when the number of system cycles 79 since the end of coverage gap G exceeds integer N, processing may proceed from operation 110 to operation 118 via path 116. If desired, CN 20 may adjust integer N over time to tweak the degree to which UE devices 10 perform thundering herd mitigation after leaving coverage gaps G. CN 20 may, for example, inform the UE devices of updates to integer N when the UE devices return on grid (e.g., processing may revert to operation 102 whenever UE device 10 returns on grid).

At operation 114 (e.g., responsive to less than or equal to N system cycles 79 having elapsed since the end of coverage gap G), UE device 10 may determine whether to (a) perform its first uplink transmission since the end of coverage gap G during the current system cycle 79 (e.g., during system cycle 79″ in a first iteration of operations 110-130), or (b) forego uplink transmission for the current system cycle 79. UE device 10 may perform (e.g., identify, calculate, generate, compute, etc.) this determination using a probabilistic operation that is based on the larger of the most recent congestion level CL1 of serving node 72 from prior to coverage gap G (e.g., as received from serving node 72 during system cycle 79′) and the most recent congestion level CL2 of serving node 72′ (e.g., as received from serving node 72′ during system cycle 79″).

The probabilistic operation may, for example, involve a so-called coin toss operation. The probabilistic (coin toss) operation may be a binary operation having either a successful (passing) result or an unsuccessful (failing) result. The probability of a successful result may be selected based on the higher of the most recent congestion level CL1 received from serving node 72 and the most recent congestion level CL2 received from serving node 72′. A higher congestion level may be associated with a lower probability of a successful result of the probabilistic operation. A lower congestion level may be associated with a higher probability of a successful result of the probabilistic operation.

As one example, UE device 10 may perform the probabilistic operation by generating a random number between upper and lower bounds (e.g., between zero and 1.0 when normalized to 1.0). While referred to herein as a random number for the sake of simplicity, the random number may be a true random number or a pseudorandom number. Once UE device 10 has generated the random number, UE device 10 may compare the random number to a predetermined range of numbers that is a continuous subset of the range spanned by the upper and lower bounds used for generating the random number. The predetermined range of numbers may be selected based on the higher of the most recent congestion level CL1 and the most recent congestion level CL2. For example, the predetermined range may be bounded by a threshold (e.g., a maximum upper threshold or a minimum lower threshold) that is selected based on the higher of the most recent congestion level CL1 and the most recent congestion level CL2.

Consider an example in which UE device 10 receives a broadcast message 90 (FIG. 6) from serving node 72 during system cycle 79′ (FIG. 5) that contains a relatively high congestion level indicator 98 equal to fourteen (e.g., where congestion level indicator 98 has a four-bit value of “1110” in implementations where congestion level indicator 98 is a four-bit value that identifies one of sixteen possible congestion levels). In this example, UE device 10 also receives a broadcast message 90 from serving node 72′ during system cycle 79″ that contains a relatively low congestion level indicator 98 equal to two (e.g., where congestion level indicator 98 has a value of “0010”). Because congestion level CL1 is greater than congestion level CL2 in this example, UE device 10 may perform the probabilistic operation (e.g., the coin toss) based on congestion level CL1 instead of congestion level CL2 (e.g., UE device 10 may ignore the congestion level CL2 received from serving node 72′ in deference to the most recent congestion level CL1 received from serving node 72 prior to the coverage gap). UE device 10 may, for example, compare its generated random number to a predetermined range of numbers that is bounded by a threshold value that is selected based on congestion level CL1. If/when the random number is within the predetermined range (e.g., less than a maximum threshold and/or greater than a minimum threshold bounding the predetermined range), UE device 10 determines that the probabilistic operation was successful and may perform its first uplink transmission to serving node 72′ during the current system cycle 79. On the other hand, if/when the random number is outside of the predetermined range (e.g., greater than a maximum threshold or less than a minimum threshold bounding the predetermined range), UE device 10 determines that the probabilistic operation was unsuccessful and may forego uplink transmission to serving node 72′ during the current system cycle 79.

For example, UE device 10 may generate a random number between zero and 1.0 (or between any other upper and lower bounds). UE device 10 may compare the random number to a predetermined range of numbers bounded by a maximum threshold such as 0.10 (or some other value). In the example where the congestion level CL1 received during system cycle 79′ is equal to fourteen (in a four-bit implementation where a value of zero corresponds to a lowest congestion level and a value of fifteen corresponds to a highest congestion level of sixteen possible congestion levels), the threshold may be set relatively low (e.g., to 0.10), which reduces the probability that the random number will be within the predetermined range (e.g., between zero and 0.10). The threshold may be set even lower when congestion level CL1 is equal to fifteen. On the other hand, in situations where the congestion level CL1 received during system cycle 79′ is lower than fourteen, the maximum threshold may be set higher (e.g., to 0.20 or another value when the congestion level is equal to ten, to 0.40 or another value when the congestion level is equal to nine, to 0.50 or another value when the congestion level is equal to eight, etc.), effectively increasing the size of the predetermined range and increasing the probability that the random number will be less than the maximum threshold. In this way, UE device 10 may be more likely to delay transmission when serving node 72 exhibited a higher congestion level than a lower congestion level. This may allow congestion level information associated with the serving node prior to the coverage gap to be independently carried over by the UE device for use in performing a first uplink transmission to serving node 72′ after the coverage gap. Given that the number of UE devices in the set is unlikely to change significantly during coverage gap G, performing a first uplink transmission after coverage gap G based on the most recent congestion level CL1 of serving node 72 from prior to coverage gap G can help to prevent a thundering herd condition for the UE devices in the set.

Consider another example in which UE device 10 receives a broadcast message 90 (FIG. 6) from serving node 72′ during system cycle 79″ (FIG. 5) that contains a congestion level indicator 98 that is higher than the last congestion level CL1 of serving node 72 from system cycle 79′. In this example, UE device 10 may perform the probabilistic operation based on the most recent congestion level CL2 of serving node 72′ (e.g., may select the predetermined range, maximum threshold, and/or minimum threshold based on the most recently received congestion level CL2) instead of based on the last congestion level CL1 of serving node 72. Put differently, UE device 10 may time its first uplink transmission after the coverage gap based on the congestion level of serving node 72′ rather than the most recent congestion level of serving node 72 from before the coverage gap.

If desired, CN 20 may set, update, and/or tune the size of the predetermined range or, equivalently, the magnitude of the maximum threshold (or minimum threshold) bounding the predetermined range, over time by providing a corresponding scaling factor to UE device 10 (e.g., in the configuration information received during operation 102). The scaling factor may, for example, configure the UE device to adjust the likelihood that the probabilistic (coin toss) operation is successful or not for different congestion levels. Put differently, UE device 10 may select the predetermined range (or equivalently the threshold(s) defining the predetermined range) based on both the higher of congestion level CL1 and CL2 and the scaling factor received from CN 20. As one example, at a first time, UE device 10 may apply a threshold of 0.10 in the coin toss of operation 114 for a given congestion level under a first scaling factor received from CN 20 and may, at a second time, apply a threshold of 0.15 (or some other value) in the coin toss of operation 114 for the same congestion level under a second scaling factor received from CN 20. As another example, UE device 10 may select the predetermined range (or equivalently the threshold(s) defining the predetermined range) using the expression max(k*CL1,CL2), where k is a constant equal to the scaling factor and max() outputs the larger of its two arguments, k*CL1 or CL2 (e.g., the predetermined range and/or the threshold(s) may be proportional to CL1 when CL1 is larger than CL2 or when k*CL1 is larger than CL2). Alternatively, the predetermined range and/or threshold(s) may be computed using the expression max(CL1,k*CL2) or max(k1*CL1,k2*CL2), where k1 and k2 are different scaling factors received from the core network. This may, for example, allow CN 20 to tune how the set of UE devices 10 mitigate thundering herd conditions as the network environment changes over time and/or as more statistical information about successful communication after coverage gaps is acquired by CN 20 over time.

If/when the probabilistic operation is successful (e.g., if/when the generated random number is within the predetermined range, less than a maximum threshold, and/or greater than a minimum threshold), processing may proceed from operation 114 to operation 128 via path 120. On the other hand, if/when the probabilistic operation is unsuccessful (e.g., if/when the generated random number is outside the predetermined range, greater than a maximum threshold, and/or less than a minimum threshold), processing may proceed from operation 114 to operation 130 via path 122.

At operation 128, responsive to the probabilistic operation producing a passing result (e.g., where the generated random number is within the predetermined range), UE device 10 may perform its first (earliest) uplink transmission to CN 20 via serving node 72′ during the current system cycle 79 (e.g., during system cycle 79″ in a first iteration of operations 110-130). The uplink signal may, for example, be a reverse link message (e.g., one or two reverse link datagrams) that carries an uplink (reverse link) data payload to be forwarded to a corresponding destination by CN 20.

At operation 132, UE device and serving node 72′ may continue to perform uplink and/or downlink communications during subsequent system cycles 79 of the current coverage period (e.g., coverage period P2 of FIG. 5). If/when UE device 10 moves back on grid, processing may loop back to operation 102. If/when UE device 10 enters another coverage gap, processing may loop back to operation 110.

At operation 130, responsive to the probabilistic operation producing a failing result (e.g., where the generated random number is outside of the predetermined range), UE device 10 does not transmit uplink signals to serving node 72′ during the current system frame 79 (e.g., during system cycle 79″ in a first iteration of operations 110-130). When the next system cycle 79 of the coverage period (e.g., coverage period P2 of FIG. 5) begins, processing loops back to operation 110 via path 134. This process may continue (e.g., iterating over operations 110, 114, 128, and 130) either until UE device 10 performs its first uplink transmission after coverage gap G (e.g., at operation 128 responsive to the generated random number falling within the predetermined range) or until N system cycles 79 have occurred since the end of coverage gap G. UE device 10 may receive a new (updated) congestion level CL2 from serving node 72′ during the broadcast interval of each system cycle 79 (e.g., at each iteration of operation 110) and may use the higher of the updated congestion level CL2 and the most recent congestion level CL1 from before the coverage gap to perform the coin toss at operation 114 (e.g., UE device 10 may continue to use the last congestion level CL1 from before the coverage gap until serving node 72′ has detected sufficient congestion such that current congestion level CL2 exceeds the last congestion level CL1).

If desired, CN 20 may set, update, and/or tune the magnitude of integer N over time using the configuration information received by UE device 10 during operation 102. This may, for example, allow CN 20 to tune how the set of UE devices 10 mitigate a thundering herd condition as network conditions change over time and/or as more statistical information about successful communication after coverage gaps is acquired by CN 20 over time.

If/when the number of system cycles since the end of coverage gap G exceeds integer N (e.g., without UE device 10 successfully performing the coin toss at operation 114 and performing its first post-coverage gap uplink transmission), processing may proceed from operation 110 to operation 118 via path 116. At operation 118, rather than performing the probabilistic operation based on the higher of the last congestion level CL1 and the most recent congestion level CL2, UE device 10 may perform the probabilistic operation based on the most recent congestion level CL2 (and not congestion level CL1). UE device 10 may, for example, select the predetermined range, maximum threshold, and/or minimum threshold for comparison to the generated random number based on the most recently received congestion level CL2 (e.g., UE device 10 may force the reported congestion level of serving node 72′ to replace the last congestion level CL1 of serving node 72 for timing its first post-coverage gap uplink transmission once N system cycles 79 have elapsed since the beginning of coverage period P2).

If/when the probabilistic operation is successful (e.g., if/when the generated random number is within the predetermined range, less than a maximum threshold, and/or greater than a minimum threshold), processing may proceed from operation 118 to operation 128 via path 124. On the other hand, if/when the probabilistic operation (e.g., the coin toss operation) is unsuccessful (e.g., if/when the generated random number is outside the predetermined range, greater than a maximum threshold, and/or less than a minimum threshold), processing may proceed from operation 118 to operation 130 via path 126.

Each UE device 10 in the set of UE devices 10 served by serving node 72′ may execute the operations of FIG. 7 to perform its respective first uplink transmission after coverage gap G. This may serve to reduce the number of simultaneous uplink transmissions to serving node 72′ during the first system cycle 79″ or any one system cycle 79 after coverage gap G, which helps to prevent or mitigate a thundering herd condition that would otherwise deteriorate user experience.

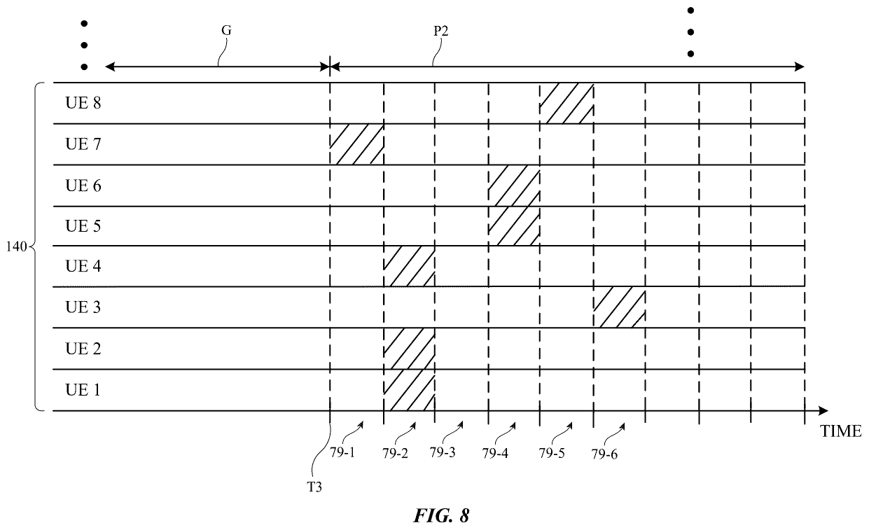

FIG. 8 is a diagram showing how the operations of FIG. 7 may probabilistically and non-deterministically spread the first uplink transmissions by the set of UE devices 10 served by serving node 72′ after coverage gap G. The horizontal axis of FIG. 8 plots time, divided into system cycles 79 (e.g., a first system cycle 79-1, corresponding to system cycle 79″ of FIG. 5, followed by a second system cycle 79-2, followed by a third system cycle 79-3, etc.). The vertical axis of FIG. 8 plots different UE devices 10 in the set of UE devices 10 served by serving node 72′. In this example, the set of UE devices includes at least eight UE devices UE1, UE2, UE3, UE4, UE5, UE6, UE7, and UE8. This is illustrative and, in practice, the set of UE devices may include any number of one or more UE devices 10.

The shaded cells of FIG. 8 represent the first uplink transmissions by the UE devices after coverage gap G (e.g., after time T3). The probabilistic (non-deterministic) algorithm performed by each of the UE devices at operations 110-130 of FIG. 7 may effectively spread or distribute the first uplink transmissions by the set of UE devices across a relatively wide range of different system cycles 79 during coverage period P2 (e.g., a greater range of system cycles 79 than when the UE devices perform their first uplink transmissions after coverage gap G based only on the current congestion level CL2 received from serving node 72′).

As shown in the example of FIG. 8, for instance, only UE device UE7 may perform its first uplink transmission after coverage gap G during system cycle 79-1 (e.g., because UE device UE7 performed a successful coin toss based on the higher of the most recent congestion level CL1 and the congestion level CL2 received during system cycle 79-1, whereas the remaining UE devices performed unsuccessful coin tosses based on the higher of the most recent congestion level CL1 and the congestion level CL2 received during system cycle 79-1). Following the same procedure, UE devices UE1, UE2, and UE3 may perform their respective first uplink transmissions after coverage gap G during the next system cycle 79-2. In practice, some system cycles such as system cycle 79-3 may contain no first uplink transmissions from the set of UE devices (e.g., for system cycles in which none of the UE devices in the set performs a successful coin toss at operations 114 and 118 of FIG. 7). UE devices UE5 and UE6 may perform their respective first uplink transmissions after coverage gap G during the next system cycle 79-4. UE device UE8 may perform its first uplink transmission after coverage gap G during system cycle 79-5. UE device UE3 may perform its first uplink transmission after coverage gap G during system cycle 79-6. This example is illustrative and non-limiting and, in practice, the UE devices in the set may perform their respective first uplink transmissions after coverage gap G during any of the system cycles 79 of coverage period P2.

In this way (e.g., by performing the operations of FIG. 7), the set of UE devices 10 served by serving node 72′ may introduce an element of randomness that breaks an otherwise deterministic uplink transmission pattern while recovering from coverage gap G. This may, for example, serve to prevent a relatively high number of the UE devices in the set (e.g., all of the UE devices in the set) from performing their respective first uplink transmissions after coverage gap G during system cycle 79-1 (e.g., during system cycle 79″ of FIG. 5) or during any one of the system cycles 79 of coverage period P2. This may serve to prevent excessive congestion at serving node 72′, undesirable collisions between uplink transmissions, and other network non-idealities associated with a thundering herd condition after coverage gap G.

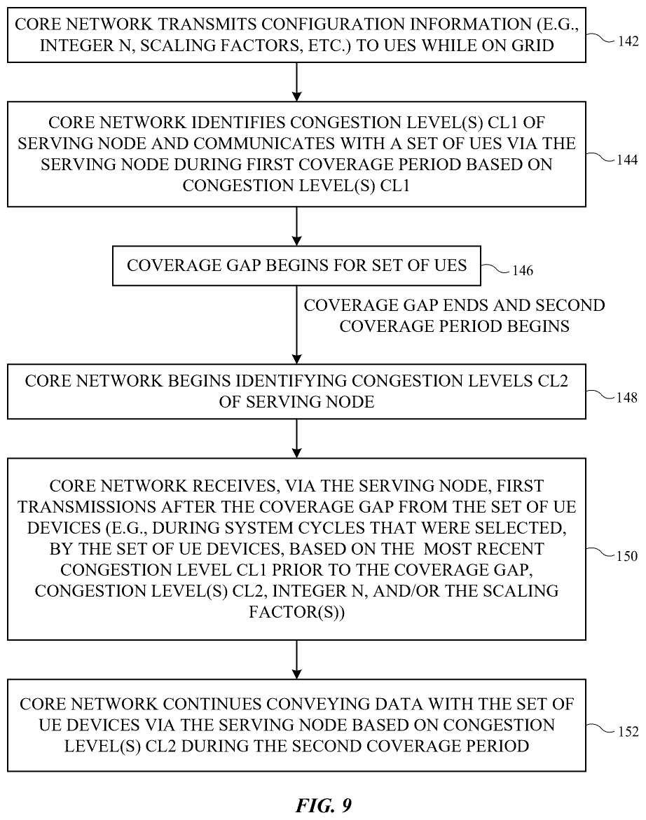

FIG. 9 is a flow chart of illustrative operations that may be performed by CN 20 in communicating with the set of UE devices 10 served by serving nodes 72 and 72′ of FIG. 5. At operation 142, CN 20 may transmit configuration information to the set of UE devices (e.g., whenever the UE devices are on grid). The UE devices may receive the configuration information while processing operation 102 of FIG. 7. The configuration information may identify integer N and any scaling factors used by the UE devices while performing the probabilistic functions of operations 114 and 118 of FIG. 7. CN 20 may, for example, transmit different (updated) integers N and/or scaling factors to on-grid UE devices over time (e.g., as network conditions and the network's knowledge of network performance characteristics change over time).

At operation 144, CN 20 may begin identifying congestion levels CL1 of serving node 72 during coverage period P1 (e.g., based on the amount of uplink and/or downlink traffic between serving node 72 and the set of UE devices served by serving node 72). CN 20 may transmit a respective broadcast message 90 during the broadcast interval of each system cycle 79 within coverage period P1. Each broadcast message 90 may include a respective congestion level indicator 98 (FIG. 6) that identifies or indicates the congestion level CL1 of serving node 79 for its corresponding system cycle 79. CN 20 may, if desired, schedule downlink (forward link) communications for the set of UE devices during coverage period P1 based on the identified congestion levels CL1 (e.g., using a load balancing scheme implemented by scheduler 68 of FIG. 4).

At operation 146, coverage gap G begins for the set of UE devices. CN 20 is unable to communicate with the set of UE devices served by serving node 72 during coverage period P1. Processing proceeds to operation 148 when coverage gap G ends and coverage period P2 (FIG. 5) begins.

At operation 148, CN 20 may begin identifying congestion levels CL2 of serving node 72′ during coverage period P2 (e.g., based on the amount of uplink and/or downlink traffic between serving node 72′ and the set of UE devices served by serving node 72′). CN 20 may transmit a respective broadcast message 90 during the broadcast interval of each system cycle 79 within coverage period P2. Each broadcast message 90 may include a respective congestion level indicator 98 (FIG. 6) that identifies or indicates the congestion level CL2 of serving node 79 for its corresponding system cycle 79. CN 20 may, if desired, schedule downlink (forward link) communications for the set of UE devices during coverage period P1 based on the identified congestion levels CL1 (e.g., using a load balancing scheme implemented by scheduler 68 of FIG. 4).

At operation 150, CN 20 may receive the first uplink transmissions after coverage gap G from each of the UE devices 10 in the set of UE devices served by serving node 72′. CN 20 may receive these first uplink transmissions spread across different system cycles 79 of coverage period P2 (e.g., as shown in FIG. 8). This probabilistic and non-deterministic distribution of first uplink transmissions may serve to mitigate or prevent a thundering herd condition from occurring after coverage gap G.

At operation 152, CN 20 may continue to convey uplink and/or downlink data with the set of UE devices 10 via serving node 72′ based on congestion levels CL2 (e.g., using a load balancing scheme implemented by scheduler 68 of FIG. 4). Processing may loop back to operation 142 whenever CN 20 updates the scaling factors to be used by UE devices 10 at operations 114 and 118 of FIG. 6 and/or whenever CN 20 updates the integer N used by UE devices 10 to switch from iterating through operation 114 to iterating through operation 118 of FIG. 7. Processing may loop back to operation 146 whenever the set of UE devices experiences another coverage gap.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

One or more elements described herein (e.g., UE devices 10, satellite 12, gateway 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-10 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 38 (e.g., storage circuitry 46 of FIG. 2 or similar storage circuitry on satellites 12, gateways 14, CN 20, network portion 18, etc.). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 38 (e.g., processing circuitry 48 of FIG. 2 or similar processing circuitry on satellites 12, gateways 14, CN 20, network portion 18, etc.). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating a user equipment (UE) device to communicate with a core network via a constellation of satellites, the method comprising:
receiving, from the core network via a first satellite in the constellation, a first broadcast message that identifies a first congestion level of the first satellite;
receiving, from the core network via a second satellite in the constellation, a second broadcast message that identifies a second congestion level of the second satellite; and
transmitting, based on a higher of the first congestion level and the second congestion level, a reverse link message to the core network via the second satellite.

2. The method of claim 1, wherein receiving the first broadcast message comprises receiving the first broadcast message during a last system cycle of a first coverage period associated with visibility of the first satellite to the UE device.

3. The method of claim 2, wherein receiving the second broadcast message comprises receiving the second broadcast message during an earliest system cycle of a second coverage period associated with visibility of the second satellite to the UE device, the second coverage period being separated from the first coverage period by a coverage gap during which the UE device is unable to communicate with the core network.

4. The method of claim 3, wherein transmitting the reverse link message comprises transmitting the reverse link message during a system cycle of the second coverage period that is selected, by the UE device, using a probabilistic operation based on the higher of the first congestion level and the second congestion level.

5. The method of claim 4, further comprising:
generating, using processing circuitry, a random number;
comparing, using the processing circuitry, the random number to a range of numbers having a boundary that is based at least in part on the higher of the first congestion level and the second congestion level;
transmitting the reverse link message during a current system cycle responsive to the random number being within the range of numbers; and
delaying transmission of the reverse link message beyond the current system cycle responsive to the random number being outside the range of numbers.

6. The method of claim 5, wherein the boundary is proportional to the higher of the first congestion level and the second congestion level.

7. The method of claim 4, wherein transmitting the reverse link message comprises:
transmitting the reverse link message based on the higher of the first congestion level and the second congestion level when the selected system cycle is within N system cycles of an end of the coverage gap; and
transmitting the reverse link message based on the second congestion level but not the first congestion level when the selected system cycle is greater than N system cycles from the end of the coverage gap.

8. The method of claim 1, wherein:
the first broadcast message has a media access control (MAC) header field that includes a first congestion level identifier identifying the first congestion level;
the first congestion level is associated with a first signal beam of the first satellite;
the first signal beam overlaps the UE device during a first time period;
the second broadcast message has a MAC header field that includes a second congestion level identifier identifying the second congestion level;
the second congestion level is associated with a second signal beam of the second satellite;
the second signal beam does not overlap the UE device during the first time period;
the second signal beam overlaps the UE device during the second time period;
the first signal beam does not overlap the UE device during the second time period; and
the UE device is unable to communicate with the core network from an end of the first time period until a beginning of the second time period.

9. A method of operating an electronic device to communicate with a core network, the method comprising:
receiving, from the core network via a first serving node, a first congestion level of the first serving node during a last system cycle of a first coverage period;
receiving, from the core network via a second serving node, a second congestion level of the second serving node during an earliest system cycle of a second coverage period, wherein the second coverage period is separated from the first coverage period by a coverage gap during which the electronic device is unable to communicate with the core network; and
transmitting, to the core network via the second serving node, an uplink signal during a system cycle of the second coverage period that is probabilistically selected, by the electronic device, based on the first congestion level when the first congestion level is greater than the second congestion level.

10. The method of claim 9, wherein the system cycle of the second coverage period is probabilistically selected, by the electronic device, based on the second congestion level when the second congestion level is greater than the first congestion level.

11. The method of claim 9, further comprising:
generating, using processing circuitry, a random number during the earliest system cycle of the second coverage period;
comparing, using the processing circuitry, the random number to a range of numbers that is bounded based on the first congestion level; and
transmitting the uplink signal during the earliest system cycle of the second coverage period responsive to the random number being within the range of numbers.

12. The method of claim 11, further comprising:
delaying transmission of the uplink signal until after the earliest system cycle of the second coverage period responsive to the random number being outside the range of numbers.

13. The method of claim 9, wherein the uplink signal comprises an earliest uplink transmission by the electronic device after an end of the coverage gap.

14. The method of claim 9, wherein the first serving node is different than the second serving node.

15. The method of claim 14, wherein the first serving node comprises a first communications satellite, the second serving node comprises a second communications satellite, the first communications satellite sets relative to a horizon of the electronic device at a beginning of the coverage gap, and the second communications satellite rises relative to a horizon of the electronic device at an end of the coverage gap.

16. The method of claim 9, wherein the first serving node is the same as the second serving node.

17. The method of claim 16, further comprising:
updating, using processing circuitry, software on the electronic device during the coverage gap, wherein the uplink signal identifies, to the core network, that the electronic device has updated the software.

18. A method of operating one or more servers of a core network to communicate with a user equipment (UE) device via a constellation of satellites, the method comprising:
transmitting, via a first satellite in the constellation during a first coverage period, a first broadcast message that identifies a first congestion level of a first signal beam of the first satellite, the first signal beam overlapping the UE device;
transmitting, via a second satellite in the constellation during a second coverage period, a second broadcast message that identifies a second congestion level of a second signal beam of the second satellite, the second signal beam overlapping the UE device, and the second coverage period being separated from the first coverage period by a coverage gap during which the core network is unable to communicate with the UE device; and
receiving an earliest reverse link transmission of the UE device after the coverage gap, the earliest reverse link transmission being received via the second signal beam of the second satellite during a system cycle that is probabilistically selected, by the UE device, based on a higher of the first congestion level and the second congestion level.

19. The method of claim 18, wherein the system cycle is probabilistically selected, by the UE device, based on a scaling factor, the method further comprising:
transmitting, the to the UE device via terrestrial-based wireless communications equipment, configuration information that changes the scaling factor.

20. The method of claim 18, wherein the first broadcast message has a media access control (MAC) header field that includes a first congestion level identifier identifying the first congestion level and wherein the second broadcast message has a MAC header field that includes a second congestion level identifier identifying the second congestion level.
